(19) United States
(12) Patent Application Publication
(10) Pub. No.: US 2026/0044828 A1
(43) Pub. Date: Feb. 12, 2026

(54) PROJECT MANAGEMENT METHOD, ELECTRONIC DEVICE, AND STORAGE MEDIUM

(71) Applicant: Beijing Zitiao Network Technology Co., Ltd., Beijing (CN)

(72) Inventors: Chunshuo YANG, Beijing (CN); Qianwen GUO, Beijing (CN); Yuzeng KOU, Beijing (CN); Yangyang XIANG, Beijing (CN); Guangshuo CAO, Beijing (CN)

(21) Appl. No.: 19/273,878

(22) Filed: Jul. 18, 2025

(30) Foreign Application Priority Data
Aug. 6, 2024 (CN) 202411074283.4

(51) Int. Cl. G06Q 10/10; G06Q 10/0631

(52) U.S. Cl. CPC G06Q 10/103; G06Q 10/063118

(57) ABSTRACT

Embodiments of the present disclosure provide a project management method, an electronic device and a storage medium. The method includes: in response to detecting a modification operation of modifying a value of a first item to a target value, determining, according to a parent item and/or a child item of the first item, whether the target value passes a check; and in response to the target value passing the check, and in response to the first item having a parent item and a parent item value of the parent item being empty or being a type of a summary value, updating the parent item value according to the target value that passes the check, where the type of the summary value indicates that the parent item value is obtained by summarizing values of other items.

### CROSS-REFERENCE TO RELATED APPLICATION

This application claims the priority to and benefits of the Chinese Patent Application, No. 202411074283.4, which was filed on Aug. 6, 2024. All the aforementioned patent applications are hereby incorporated by reference in their entireties.

### TECHNICAL FIELD

The present disclosure relates to the field of computer technology, and in particular, to a project management method and apparatus, and an electronic device.

### BACKGROUND

With the development of computers, users can use electronic devices to implement various functions. For example, users can interact with other users through electronic devices, and can also use electronic devices to boost work.

In some scenarios, a tool or platform (such as a project management system) based on data management can be built, to accelerate project launch and avoid project risks by creating a standardized business process.

### SUMMARY

This Summary is provided to introduce concepts in a simplified form that are described in detail in the following Detailed Description section. This Summary is not intended to identify key or essential features of the claimed technical solution, nor is it intended to be used to limit the scope of the claimed technical solution.

At least one embodiment of the present disclosure provides a project management method. The method includes: in response to detecting a modification operation of modifying a value of a first item to a target value, determining, according to a parent item and/or a child item of the first item, whether the target value passes a check; and in response to the target value passing the check, and in response to the first item having the parent item and a parent item value of the parent item being empty or being a type of a summary value, updating the parent item value according to the target value that passes the check, where the type of the summary value indicates that the parent item value is obtained by summarizing values of other items.

At least one embodiment of the present disclosure provides a project management apparatus. The apparatus includes: a check unit, configured to: in response to detecting a modification operation of modifying a value of a first item to a target value, determine, according to a parent item and/or a child item of the first item, whether the target value passes a check; and an update unit, configured to: in response to the target value passing the check, and in response to the first item having the parent item and a parent item value of the parent item being empty or being a type of a summary value, update the parent item value according to the target value that passes the check, where the type of the summary value indicates that the parent item value is obtained by summarizing values of other items.

At least one embodiment of the present disclosure provides an electronic device. The electronic device includes: at least one processor; and at least one storage apparatus, configured to store one or more programs, where the one or more programs, when executed by the one or more processors, cause the one or more processors to perform the project management method according to any embodiment provided by the disclosure.

In a fourth aspect, an embodiment of the present disclosure provides a computer-readable medium, storing a computer program which, when executed by a processor, performs the steps of the project management method according to any embodiment provided by the disclosure.

### BRIEF DESCRIPTION OF DRAWINGS

The above and other features, advantages, and aspects of embodiments of the present disclosure become more apparent when taken in conjunction with the drawings and with reference to the following detailed description. Throughout the drawings, the same or similar reference numbers refer to the same or similar elements. It should be understood that the drawings are schematic and that parts and elements are not necessarily drawn to scale.

FIG. 1 is a flowchart of a project management method of at least one embodiment provided by the present disclosure.

FIG. 2 is a flowchart of the project management method of at least one embodiment provided by the present disclosure.

FIG. 3A, FIG. 3B, FIG. 3C, FIG. 3D, FIG. 3E, and FIG. 3F are schematic diagrams of an application scenario of the project management method of at least one embodiment provided by the present disclosure.

FIG. 4 is a schematic diagram of an application scenario of the project management method of at least one embodiment provided by the present disclosure.

FIG. 5 is a schematic structural diagram of an embodiment of a project management apparatus of at least one embodiment provided by the present disclosure.

FIG. 6 is an exemplary system architecture diagram to which the project management method in at least one embodiment of the present disclosure can be applied.

FIG. 7 is a schematic diagram of a basic structure of an electronic device of at least one embodiment provided by the present disclosure.

### DETAILED DESCRIPTION

The embodiments of the present disclosure are described in more detail below with reference to the drawings. Although some embodiments of the present disclosure are shown in the drawings, it should be understood that the present disclosure can be implemented in various manners and should not be construed as being limited to the embodiments described herein. Rather, these embodiments are provided for a thorough and complete understanding of the present disclosure. It should be understood that the drawings and the embodiments of the present disclosure are only for illustrative purposes, and are not intended to limit the protection scope of the present disclosure.

It should be understood that the steps described in the method implementations of the present disclosure can be performed in different orders and/or in parallel. In addition, the method implementations may include additional steps and/or omit the performance of the illustrated steps. The scope of the present disclosure is not limited in this regard.

The term “include/comprise” and variations thereof as used herein are open-ended inclusions, that is, “include/comprise but not limited to”. The term “based on” is “based at least in part on”. The term “an embodiment” means “at least one embodiment”; the term “another embodiment” means “at least one further embodiment”; the term “some embodiments” means “at least some embodiments”. Relevant definitions of other terms will be given in the following description.

It should be noted that the concepts of “first” and “second” mentioned in the present disclosure are only used to distinguish different apparatuses, modules, or units, and are not used to limit the order or interdependence of functions performed by these apparatuses, modules, or units.

It should be noted that the modifications of “one” and “a plurality of” mentioned in the present disclosure are illustrative rather than restrictive, and those skilled in the art should understand that unless the context clearly indicates otherwise, they should be understood as “one or more”.

The names of messages or information exchanged between a plurality of apparatuses in the implementations of the present disclosure are only for illustrative purposes, and are not intended to limit the scope of these messages or information.

Here, for ease of description, some concepts that may be involved in the present disclosure are introduced first.

Project management system: a software system for helping a project team to plan, organize, execute, and monitor a project process.

Space, a basic unit for organizing collaboration, which may be management of a single project or a collection of a plurality of projects.

Work item, a work matter of team collaboration, or a matter collection of project disassembly. Work items may be divided into different types according to different contents, for example, features, issues, versions, iterations, milestones, deliverables, etc.

Feature, which may refer to a software function required by a user to solve a certain problem/achieve a certain goal, and it can help team members track specific details.

Issue, which refers to a business requirement that does not conform to the initially defined business requirement. For example, a pop-up window does not display, etc.

View, a solidified collection of work item query dimensions that are highly concerned within a team, which may also be referred to as a view double special item. A view may have a plurality of types, such as a table, a list, a kanban, a gantt chart, a metric, etc. A table may be an arrangement and combination of field information, and data is arranged in a cell mode. A gantt chart may display a project progress through a bar graph in a time dimension. The metric is a continuous quantitative process of data definition, collection, and analysis of software development projects, processes, and products. For example, issue throughput, quality, cycle, and manpower estimate, etc.

Role, various roles involved in a project, and a project requires cooperation and support from different roles.

WBS (Work Breakdown Structure) planning sheet, that is, a work breakdown structure planning sheet, which may also be referred to as a WBS planning sheet, or simply referred to as a planning sheet.

Process, a basic step of a life cycle of a matter, which is composed of process nodes and execution modes in an orderly manner. A node may refer to a stage division point of a process.

Node owner, a person responsible for a node task, who may or may not be a processor of the node task.

Node participant, a processor of a node task, but not a person responsible for the node task.

Sub-process node, a process subdivision field or a task package in a large-scale planning process, and another process introduced in a current process is called a sub-process. Other nodes may be disassembled under a sub-process node.

Sub-task, a simple matter at the end of a process, and the personnel disassemble or record the current to-do matters of the project.

Sub-work item, more detailed transaction management at the end of a process, and front-line executives disassemble or record current to-do matters of the project.

Planned scheduling, a time arrangement of a certain activity or task.

Planned duration, a number of days of a certain activity or task minus working days.

Estimate, actual person-days invested.

Actual work hours, the actual number of hours invested.

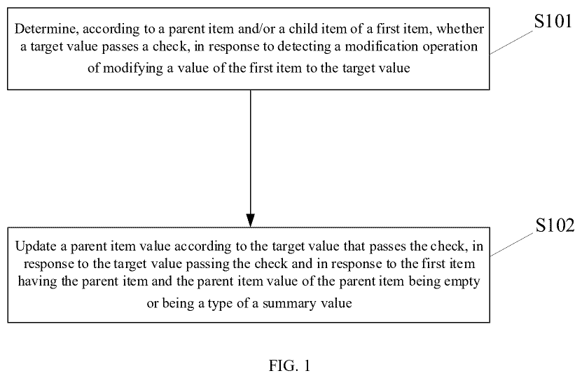

Please refer to FIG. 1, which shows a flowchart of a project management method of at least one embodiment provided by present disclosure. This embodiment can be applied to a project management system. As shown in FIG. 1, the project management method includes the following steps.

S101: determine, according to a parent item and/or a child item of a first item, whether a target value passes a check, in response to detecting a modification operation of modifying a value of the first item to the target value.

S102: update a parent item value according to the target value that passes the check, in response to the target value passing the check and in response to the first item having the parent item and the parent item value of the parent item being empty or being a type of a summary value.

The type of the summary value indicates that the parent item value is obtained by summarizing values of other items.

The first item may refer to a field of a node, a work item, or a task that is operated in the project management system, and may be a field in any project. Here, fields (for example, a planned scheduling, a planned duration, an estimate, and actual work hours) of project elements (for example, a node, a sub-process node, a sub-task, or a sub-work item) for which a parent-child relationship can be set may all be used as the first item.

In some embodiments, in response to there being a parent-child relationship between an instance to which the first item belongs and an instance to which a parent item belongs, the first item and the parent item may have a parent-child relationship. As an example, in response to there being a parent-child relationship between a work item A and a work item A1, there is a parent-child relationship between a planned scheduling of the work item A and a planned scheduling of the work item A1.

The target value may refer to a new value that a user wants to set for the first item, and the value needs to pass a check by a check rule.

The check may be a checking process to ensure that data input or modified by the user conforms to a preset rule of the project management system.

The parent item may be a corresponding field of a work item at an upper level of a current work item (an instance to which the first item belongs) in a hierarchical structure of the project.

The child item may be a project element at a lower level of the current work item (the first item) in the hierarchical structure of the project.

A type of a summary value: a parent item value, which is automatically calculated by summarizing values of its child items.

A type of a fill value: a value directly input by a user or manually set, and not calculated by summarizing values of child items.

In some embodiments, the verification process in S101 may include: when the parent item has no value, after the child item is filled, automatically summarizing and displaying a value of the child item to the parent item; when the parent item has a value, and the value is a summary value of the child item, after the child item is updated, automatically updating a value of the parent item; when the parent item is modified, the value cannot be less than that of the child item; in response to the parent item having a value, but the value is a filled value, when the child item is updated, the value cannot exceed that of the parent item; and when the parent item is modified, the value cannot be less than the existing value of the child item.

This embodiment provides a project management method. In response to detecting a modification operation of modifying a value of a first item to a target value, determining, according to a parent item and/or a child item of the first item, whether the target value passes a check; and in response to the target value passing the check, and in response to the first item having the parent item and a parent item value of the parent item being empty or being a type of a summary value, updating the parent item value according to the target value that passes the check, where the type of the summary value indicates that the parent item value is obtained by summarizing values of other items. In this method, not only can the value of the first item be updated correctly according to the parent-child relationship, but also the parent item value can be automatically summarized according to the target value modified by the user when the parent item value is empty or the parent item value is a type of a summary value. Therefore, the accuracy of data and the efficiency of operations in the project management system are improved.

In some embodiments, the method further includes: in response to the target value passing the check, displaying the target value. Therefore, the target value that passes the check may be displayed in a timely manner, so that the displayed target value is more accurate, the manual verification cost of project management is reduced, and the accuracy and timeliness of data in project management are improved.

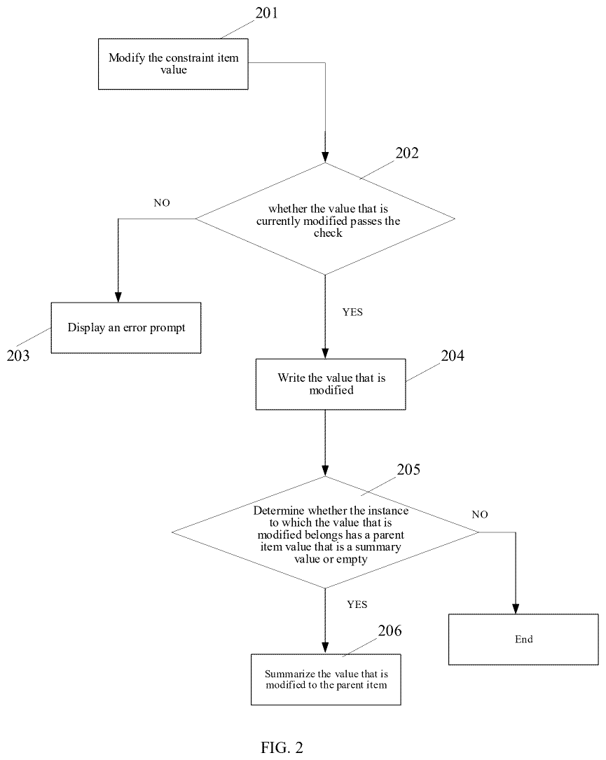

Please refer to FIG. 2, which shows a flowchart of the project management method of at least one embodiment provided by the present disclosure.

At step 201, modify the constraint item value.

The above-mentioned first item may also be referred to as a constraint item, and the first item value may be referred to as a constraint item value.

Here, the point where the constraint item value changes may be set according to actual scenarios.

For example, the operation point may include a details page. Node card, fill in scheduling, estimate, and actual work hours; task, fill in scheduling, estimate, and actual work hours; node details control, fill in scheduling;

For example, the operation point may include a node information control. Fill in the field set in the overall scheduling of the work item.

For example, the operation point may include a swim lane diagram, modify scheduling and estimate,

For example, the operation point may include controls in the view-personnel and scheduling, modify scheduling and estimate. The operation point may include a manpower gantt chart, a work item gantt chart, drag scheduling and estimate in the view.

For example, the operation point may include a view part in a project management module in other applications, a personnel and scheduling control, and an overall scheduling field, to modify scheduling and estimate.

For example, the operation point may include mobile node card scheduling and task scheduling. For the node card scheduling, scheduling and estimate can be filled in. For the task scheduling, scheduling and estimate can be filled in.

For example, the operation point may include work hour registration in plug-ins of other applications, and write work hours.

For example, the operation point may include modifying node scheduling, estimate, and actual work hours in other interfaces.

For example, the operation point may include modifying overall scheduling and estimate fields in automatic operations. When the check fails, there is no need to report an error, and the execution may be unsuccessful.

For example, the operation point may include scheduling synchronization in space linkage, to synchronize values of scheduling. When the check fails, there is no need to report an error, and the execution may be unsuccessful.

At step 202, whether the value that is currently modified passes the check.

At step 203, if not, display an error prompt.

The types of error prompts may be distinguished according to the hierarchy type of the first item and the relative relationship between the first item and the conflict.

As an example, when the scheduling exceeds that of the parent, it is prompted that: the start time is earlier than the start time of the parent/the end time is later than the end time of the parent; when the scheduling is less than that of the child, it is prompted that: the start time is later than the start time of the child/the end time is earlier than the end time of the child.

As an example, the duration exceeds the duration of the parent, or the scheduling exceeds that of the parent. The duration is less than the duration of the child, or the scheduling is less than that of the child.

As an example, the estimate exceeds the estimate of the parent, or the estimate is less than that of the child.

As an example, the actual work hours exceed the work hours of the parent, or the actual work hours are less than those of the child.

At step 204, if so, write the value that is modified.

Here, the value that is modified may be written at the operation point.

At step 205, determine whether the instance to which the value that is modified belongs has a parent item value that is a summary value or empty.

At step 206, if so, summarize the value that is modified to the parent item.

In response to the determination in step 205 being negative, the process ends.

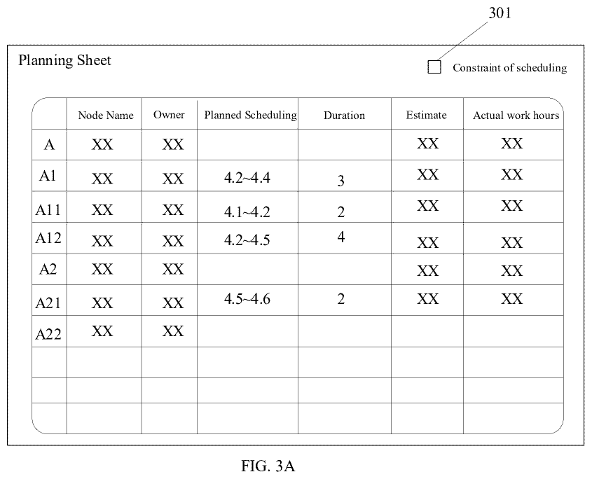

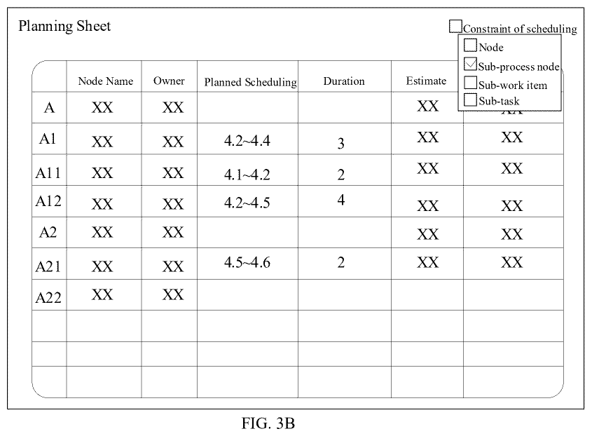

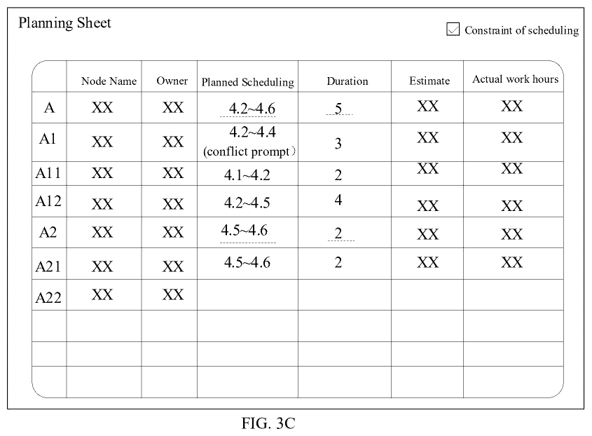

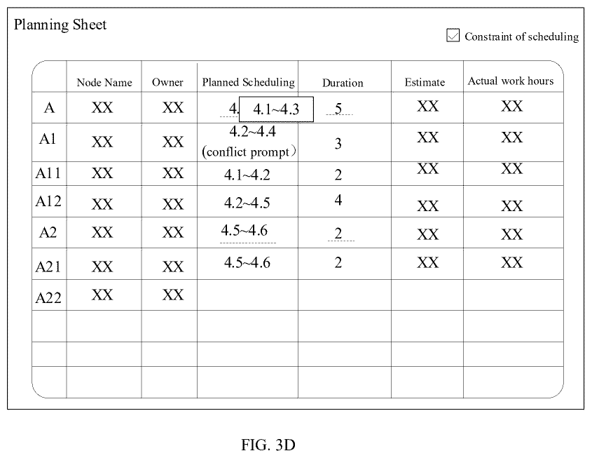

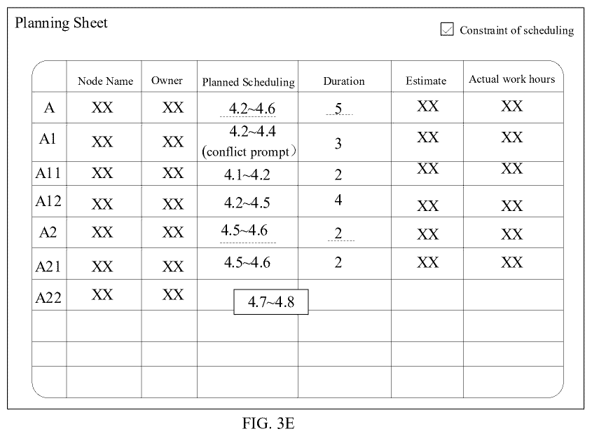

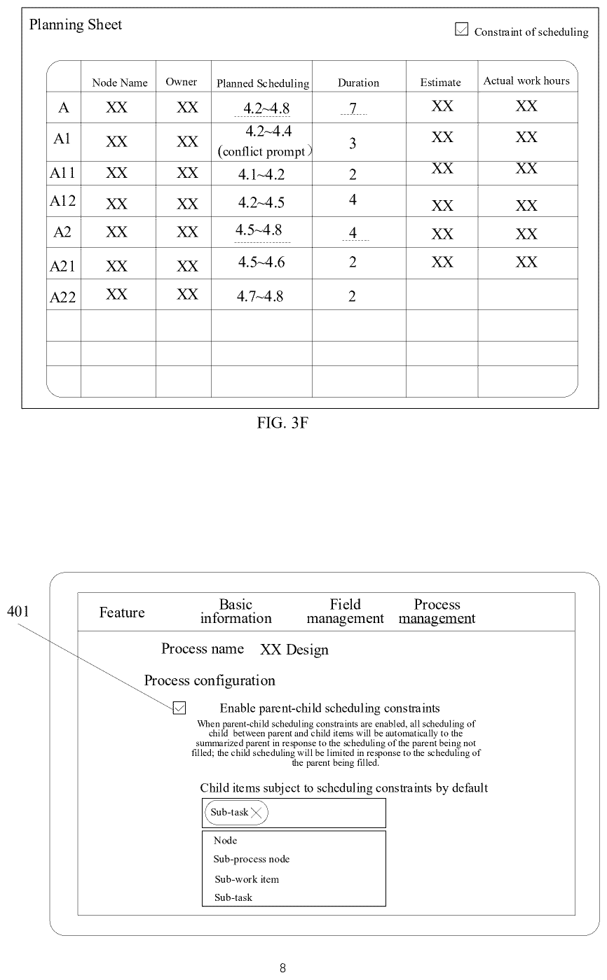

As an example, please refer to FIG. 3A, FIG. 3B, FIG. 3C, FIG. 3D, FIG. 3E, and FIG. 3F. FIG. 3A, FIG. 3B, FIG. 3C, FIG. 3D, FIG. 3E, and FIG. 3F illustrate implementations of some embodiments of the present application by using, as an example, the scheduling and duration of a process node in a planning sheet.

FIG. 3A shows that child items of a process node A in the planning sheet include sub-process nodes A1 and A2. Child items of the sub-process node A1 include sub-process nodes A11 and A12. Child items of the sub-process node A2 include sub-process nodes A21 and A22. The fields of the process node in the planning sheet may include a node name, an owner, a planned scheduling, a duration, an estimate, and actual work hours.

In FIG. 3A, the first constraint control 301 is in an off state. The planned scheduling of the process nodes A1, A11, A12, and A21 has filled values. The planned scheduling of the process nodes A, A2, and A22 has no filled value.

In FIG. 3B, the first constraint control 301 is shown to be turned on. In the planning sheet, a sub-process node may be selected as a parent-child constraint item.

FIG. 3C shows that after the first constraint control is turned on in FIG. 3B, the existing filled values in the planning sheet may be checked to obtain a conflict between the planned scheduling (4.2 to 4.4) of A1 and the planned scheduling (4.2 to 4.5) of A12, that is, the end time of the parent item is earlier than the end time of the child item. Then, automatic summarization may be performed to obtain the planned duration of A2 as 4.5 to 4.6; and the planned scheduling of A is 4.2 to 4.6. Subsequently, a linkage between the duration and the planned scheduling may be performed to obtain the duration of A2 as 2, and the duration of A is 5. The values obtained by automatic summarization may be displayed distinguishably from the filled values (for example, the values obtained by summarization are displayed with underlines).

In FIG. 3D, it is shown that the planned scheduling of A is modified, and it is shown in the modification box that the planned scheduling is expected to be modified to 4.1 to 4.3. However, since the latest start time of the child item of A is 4.6, and 4.3 that is expected to be modified is earlier than 4.6, the modified value does not pass the check; therefore, after the modification box in FIG. 3D disappears, the planned scheduling in FIG. 3D will not change.

In FIG. 3E, it is shown that the planned scheduling of A22 in the planning sheet is filled, and the filled value is 4.7 to 4.8. Since the planned scheduling of A2 and A are summary values, the parent item of A22 has no filled value, and A22 passes the check, and the planned scheduling of A22 may be used as a basis of summarization and linkage.

In FIG. 3F, after the planned scheduling of A22 is filled in FIG. 3E, the planned scheduling of A22 is displayed as 4.7 to 4.8, the planned scheduling of A2 is displayed as 4.5 to 4.8, and the planned scheduling of A is displayed as 4.2 to 4.8; the duration of A22 is displayed as 2, the duration of A2 is displayed as 4, and the duration of A is displayed as 7.

In some embodiments, S101 may include one or more of followings.

In response to the first item having a parent item, determining that the target value passes the check in response to a parent item value of the parent item being empty.

In response to the first item having a parent item, determining that the target value passes the check in response to the parent item value of the parent item being not empty and being a type of a summary value.

In response to the first item having a parent item, determining whether the target value is greater than the parent item value in response to the parent item value of the parent item being not empty and being a type of a fill value; and determining that the target value passes the check in response to the target value being not greater than the parent item value.

In response to the first item having a parent item, determining whether a time range indicated by the target value is greater than a time range indicated by the parent item value in response to the parent item value of the parent item being not empty and being a type of a fill value; and determining that the target value passes the check in response to the time range indicated by the target value being not greater than the time range indicated by the parent item value.

Time range: start and end times of a work item, which may be used in a logic of the check to ensure temporal rationality and continuity. For example, a planned duration may be a time range.

In this manner, when the parent item value is empty or a type of a summary value, automatic summarization is performed according to the first item value; and when there is a filled parent item value, the comparison between the target value and the parent item value ensures the logical relationship and data consistency between items with a parent-child relationship.

In some embodiments, S101 includes one or more of followings.

In response to the first item having a child item, determining whether the target value is less than the child item value in response to a child item value of the child item being not empty; and determining that the target value passes the check in response to determining that the target value is not less than the child item value.

In response to the first item having a child item, determining whether a time range indicated by the target value is less than a time range indicated by the child item value in response to a child item value of the child item being not empty; and determining that the target value passes the check in response to determining that the time range indicated by the target value is not less than the time range indicated by the child item value.

In this manner, in response to the first item having a child item, the comparison between the target value and the child item value ensures the logical relationship and data consistency between items with a parent-child relationship.

In some embodiments, the method further includes: in response to detecting the modification operation of modifying the value of the first item to the target value, determining whether an instance to which the first item belongs is a constraint type that is preset; and if so, in response to detecting the modification operation of modifying the value of the first item to the target value, determining, according to the parent item and/or the child item of the first item, whether the target value passes the check.

The constraint type that is preset includes one or more of: a sub-process node, a node, a sub-task, or a sub-work item.

In some embodiments, the method further includes: configuring the constraint type in a work item management space of the project management system.

In some embodiments, the method further includes: in response to a first constraint control of a planning scheduling being in an on state, configuring the constraint type in a planning sheet interface of the project management system.

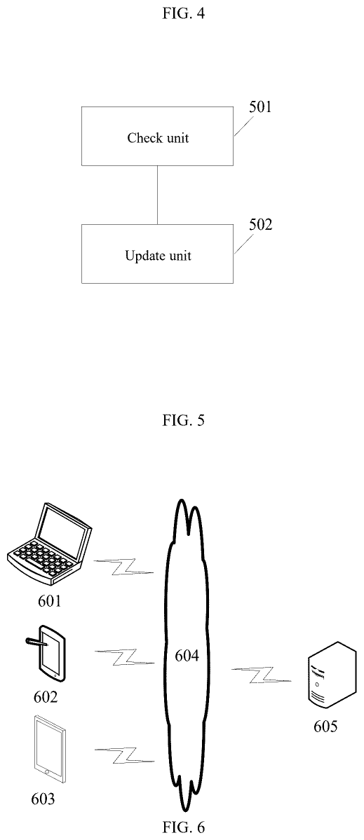

As an example, reference may be made to FIG. 4, which shows the configuration of the constraint type in the work item management space interface.

In FIG. 4, the work item management space interface may include a second constraint control 401, and when the second constraint control 401 is in an on state, the constraint type may be configured. Candidates of the constraint type may include a node, a sub-process node, a sub-work item, and a sub-task. In FIG. 4, a task is selected as the constraint type.

In this manner, the user is allowed to configure the constraint type in the project management system, which provides flexibility and customization, so that the project management can adapt to different features of project management.

In some embodiments, the step in which in response to the first constraint control of the planning sheet being in the on state, the constraint type is configured in the planning sheet interface of the project management system includes one or more of followings: configuring the constraint type for a plurality of work items in the planning sheet; and configuring the constraint type for a single work item in the planning sheet.

Optionally, the constraint type applicable to a single work item may be configured for the single work item in a single row of the planning sheet.

Optionally, the constraint type may be centrally configured in the first constraint control of the planning sheet.

When an individually configured constraint type conflicts with a centrally configured constraint type in the planning sheet, the individually configured constraint type is applied to the work item, and the centrally configured constraint type is applied to other work items without individual configuration.

In this manner, the configuration option of the constraint type is provided in the planning sheet interface, and the user is allowed to set constraints for a single work item or a plurality of work items, which improves the functionality and flexibility of the planning sheet.

In some embodiments, the method further includes: in response to the target value failing to pass the check, displaying first prompt information.

The first prompt information is used to prompt that the target value conflicts with the parent item and/or the child item.

As an example, reference may be made to the first prompt information shown in FIG. 3C that prompts a conflict of planned scheduling for A1.

In this manner, the user can be provided with timely feedback information for guiding the user to operate or prompting the user to pay attention to the conflict problem. An error prompt is provided when the check fails, which helps the user quickly identify and solve the data conflict, and improves the user experience and the accuracy of data input.

In some embodiments, the method further includes: before the modification operation, displaying second prompt information for the first item.

The second prompt information is used to prompt a value range of the first item, where the value range of the first item is generated according to the parent item and/or the child item of the first item.

As an example, the value range of the first item may be displayed when the user selects the field value (indicating that the user may modify the field value) but does not input a new field value.

In this manner, the prompt information is provided before the user performs the modification operation, and the value range of the first item is displayed, which helps the user know the range of the expected value and prevents incorrect data input.

In some embodiments, third prompt information is displayed in response to a trigger operation on a work item value with the type of the summary value.

The third prompt information is used to prompt that in response to the work item value of the type of the summary value being modified, the work item value that is modified constitutes a constraint on a child item corresponding to the work item value.

In some embodiments, the work item value that is modified is of a type of a fill value.

In some embodiments, the method further includes: displaying the work item value of the type of the fill value and the work item value of the type of the summary value in different display styles (for example, a type of a summary value is indicated by a dashed underline in FIG. 3C).

In this manner, the fill value and the summary value are distinguished by different display styles, and an additional prompt is provided when the summary value is modified, which enhances the intuitiveness and usability of the user interface.

In some embodiments, the method further includes: in response to deleting the target value, generating the summary value of the first item according to the child item of the first item.

In this manner, the summary value is automatically generated according to the child item after the target value is deleted, which reduces the feature for manual operations and improves the automation level of data processing.

In some embodiments, the content type of the first item includes one or more of: a planned scheduling, a planned duration, an estimate, and actual work hours.

Optionally, the planned duration may be referred to as a duration.

Optionally, a normal node may be referred to as a node.

In this manner, the content type of the first item includes a planned scheduling, a planned duration, an estimate, actual work hours, etc., which can realize automatic check and summarization for numerical fields with a parent-child relationship.

In some embodiments, a linkage exists between the planned scheduling and the duration. The first item is the planned scheduling, and the target value is a value of the planned scheduling; and the method further includes: in response to the value of the planned scheduling passing the check, updating a value of a duration according to the value of the planned scheduling that passes the check.

In some embodiments, the check rule for the planned scheduling is as follows.

Here, the check rule of the planned scheduling for the sub-process node is as follows.

The check for the scheduling of the parent item (that is, a parent process node, a root instance): in response to there being a parent process node, and the scheduling of the parent process being not empty and not a summary value, the start time cannot be earlier than the start time of the parent sub-process, and the end time cannot be later than the end time of the parent sub-process; in response to there being no parent process node, and the overall scheduling of the root instance being not empty and not a summary value, the start time of the scheduling cannot be earlier than the start time of the overall scheduling of the root instance, and the end time of the scheduling cannot be later than the end time of the overall scheduling of the root instance (an overall scheduling field that can be configured in a basic information page of the work item).

The check for the scheduling of the child item (node): in response to there being nodes in the sub-process, the start time of the scheduling cannot be later than the earliest start time of the nodes, and the end time of the scheduling cannot be earlier than the latest end time of the nodes.

Here, the check rule for the planned scheduling of a normal node is as follows.

The check for the scheduling of the parent item (sub-process node, root instance, sub-work item): in response to there being a parent process node and/or a sub-work item, and the scheduling of the parent being not empty and not a summary value, when the scheduling is modified, the start time cannot be earlier than the start time of the parent, and the end time cannot be later than the end time of the parent; in response to there being no parent process node, and the overall scheduling of the root instance being not empty and not a summary value, when the scheduling is modified, the start time cannot be earlier than the start time of the overall scheduling of the root instance, and the end time cannot be later than the end time of the overall scheduling of the root instance (an overall scheduling field configured in the basic information page of the work item).

The check for the scheduling of the child item (sub-task, sub-work item): in response to there being only sub-tasks under the node, when the scheduling is modified, the start time cannot be later than the earliest start time of the tasks, and the end time of the scheduling cannot be earlier than the latest end time of the tasks; in response to there being only sub-work items under the node, when the scheduling is modified, the start time cannot be later than the earliest start time of the first-level sub-work item, and the end time of the scheduling cannot be earlier than the latest end time of the tasks; when both are included, the scheduling of the sub-task and the first-level sub-work item are calculated in a combined manner. Here, the check rule for the planned scheduling of the sub-task is as follows.

The check for the scheduling of the parent item (node): in response to the scheduling of the parent node being not empty and not a summary value, when the scheduling is modified, the start time cannot be earlier than the start time of the parent node, and the end time cannot be later than the end time of the parent node.

Here, the check rule for the planned scheduling of the sub-work item is as follows.

The check for the scheduling of the parent item (node, other sub-work item): in response to the scheduling of the parent being not empty and not a summary value, when the scheduling is modified, the start time cannot be earlier than the start time of the parent scheduling, and the end time cannot be later than the end time of the parent scheduling.

The check for the scheduling of the child item (other sub-work item, node under the sub-work item): in response to there being nodes and other sub-work items under the sub-work item, when the scheduling is modified, the start time cannot be later than the earliest start time of the first-level sub-work item and/or the nodes, and the end time of the scheduling cannot be later than the latest end time of the first-level sub-work item and/or the nodes.

In some embodiments, reference may be made to the summarization rule for the planned scheduling as follows.

Here, a summarization rule for the planned scheduling of a sub-process node is as follows.

In response to there being a parent process node, and the scheduling of the parent process node being empty or a summary value, the value that is modified is summarized and appended to the scheduling of the parent. The duration of the parent process node is increased through linkage. In response to there being no parent process node and/or sub-work item, and the overall scheduling of the root instance being empty or a summary value, the value that is modified is summarized and appended to the overall scheduling of the root instance. The root instance has no duration and does not need to change. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. In response to the currently modified scheduling being summarized to the parent exceeding the filled value of the parent's parent scheduling, the modification is unsuccessful.

Here, a summarization rule for the planned scheduling of a normal node is as follows.

In response to there being a parent process node and/or a sub-work item, and the scheduling of the parent being empty or a summary value, the value that is modified is summarized and appended to the scheduling of the parent. The duration of the parent is increased through linkage. In response to there being no parent process node and/or sub-work item, and the overall scheduling of the root instance being empty or a summary value, the value that is modified is summarized and appended to the overall scheduling of the root instance. The root instance has no duration and does not need to change. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified scheduling is summarized to the parent exceeding the filled value of the parent's parent scheduling, the modification is unsuccessful.

Here, a summarization rule for the planned scheduling of a sub-task is as follows.

In response to the scheduling of the parent node being empty or a summary value, the value that is modified is summarized and appended to the scheduling of the parent. The duration of the parent node is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. In response to the currently modified scheduling being summarized to the parent exceeding the filled value of the scheduling for the parent's other parent, the modification is unsuccessful.

Here, a summarization rule for the planned scheduling of a sub-work item is as follows.

In response to the scheduling of the parent node and/or the sub-work item being empty or a summary value, the value that is modified is summarized and appended to the scheduling of the parent. The duration of the parent is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified scheduling is summarized to the parent exceeding the filled value of the scheduling for the parent's other parent, the modification is unsuccessful.

Here, the check and summarization rule for the planned duration are as follows.

In some embodiments, the check rule for the planned duration is as follows.

Here is the check rule for the planned duration of the sub-process node.

The check for the duration of the parent item (parent process node): in response to the duration of the parent being not empty and not a summary value, when the duration is modified, the duration cannot exceed the duration of the parent, and the time range cannot be greater than the value of the duration of the parent.

The check for the duration of the child item: in response to there being nodes in the sub-process, when the duration is modified, the duration cannot be less than the duration between the earliest start time and the latest end time of the nodes thereunder.

Here, the check rule for the planned duration of a normal node is as follows.

The check for the duration of the parent item (sub-process node, root instance, sub-work item): in response to the duration of the parent being not empty and not a summary value, when the duration is modified, the duration cannot exceed the duration of the parent, and the time range cannot be greater than the value of the duration of the parent.

The check for the duration of the child item (sub-task, sub-work item): in response to there being only sub-tasks under the node, when the duration is modified, the duration cannot be less than the duration of the sub-task, and cannot be less than the duration between the earliest start time and the latest end time of the tasks thereunder; in response to there being only sub-work items under the node, when the duration is modified, the duration cannot be less than the duration of the sub-work item, and cannot be less than the duration between the earliest start time and the latest end time of the first-level sub-work item; when both are included, the scheduling of the sub-task and the first-level sub-work item are calculated in a combined manner.

Here, the check rule for the planned duration of the sub-task is as follows.

The check for the duration of the parent item (node): in response to the duration of the parent being not empty and not a summary value, when the duration is modified, the duration cannot exceed the duration of the parent, and cannot be less than the duration between the start time and the end time of the parent node.

Here, the check rule for the planned duration of the sub-work item is as follows.

The check for the duration of the parent item (node, other sub-work item): in response to the duration of the parent being not empty and not a summary value, when the duration is modified, the duration cannot exceed the duration of the parent, and cannot be less than the duration between the start time and the end time of the parent scheduling.

The check for the duration of the child item (other sub-work item, node under the sub-work item): in response to there being nodes and other sub-work items under the sub-work item, when the duration is modified, the duration cannot be less than the duration between the earliest start time of the first-level sub-work item and/or the nodes and the latest start time of the first-level sub-work item and/or the nodes, and the duration cannot be less than the duration of the sub-work item.

In some embodiments, reference may be made to the summarization rule for the planned duration as follows.

Here, the summarization rule for the planned duration of a sub-process node is as follows.

In response to there being a parent process node, and the duration of the parent process node being empty or a summary value, the value that is modified needs to be summarized and appended to the duration of the parent. The scheduling of the parent process node is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified scheduling is summarized to the parent exceeding the filled value of the parent's other parent duration, the modification is unsuccessful. When the duration does not exceed, but the scheduling plus the duration exceeds the value of the parent's other parent scheduling, the modification is also unsuccessful.

Here, the summarization rule for the planned duration of a normal node is as follows.

In response to there being a parent process node and/or a sub-work item, and the duration of the parent being empty or a summary value, the value that is modified is summarized and appended to the duration of the parent. The scheduling of the parent is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified scheduling is summarized to the parent exceeding the filled value of the parent's other parent duration, the modification is unsuccessful. When the duration does not exceed, but the scheduling plus the duration exceeds the value of the parent's other parent scheduling, the modification is also unsuccessful.

Here, the summarization rule for the planned duration of a sub-task is as follows.

In response to the duration of the parent node being empty or a summary value, the value that is modified is summarized and appended to the duration of the parent. The scheduling of the parent node is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified scheduling is summarized to the parent exceeding the filled value of the parent's other parent duration, the modification is unsuccessful. When the duration does not exceed, but the scheduling plus the duration exceeds the value of the parent's other parent scheduling, the modification is also unsuccessful.

Here, the summarization rule for the planned duration of a sub-work item is as follows.

In response to the duration of the parent node and/or the sub-work item being empty or a summary value, the value that is modified is summarized and appended to the duration of the parent. The scheduling of the parent is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified scheduling is summarized to the parent exceeding the filled value of the parent's other parent duration, the modification is unsuccessful.

In some embodiments, the check rule for the estimate is as follows.

Here, the check rule for the estimate of the sub-process node is as follows.

The check for the estimate of the parent item (parent process node): in response to the estimate of the parent being not empty and not a summary value, when the estimate is modified, the value range cannot be greater than the estimate value of the parent.

The check for the estimate of the child item (node): in response to there being nodes in the sub-process, when the estimate is modified, the estimate cannot be less than the sum of the estimates of the nodes thereunder.

Here, the check rule for the estimate of the normal node is as follows.

The check for the estimate of the parent item (sub-process node, root instance, sub-work item): in response to the estimate of the parent being not empty and not a summary value, when the estimate is modified, the time range cannot be greater than the estimate value of the parent.

The check for the estimate of the child item (sub-task, sub-work item): in response to there being only sub-tasks under the node, when the estimate is modified, the estimate cannot be less than the sum of the estimates of the tasks thereunder. When there are only sub-work items under the node, when the duration is modified, the duration cannot be less than the duration between the earliest start time and the latest end time of the first-level sub-work item. When both are included, the scheduling of the sub-task and the first-level sub-work item are calculated in a combined manner.

Here, the check rule for the estimate of the sub-task as follows.

The check for the estimate of the parent item (node): in response to the estimate of the parent being not empty and not a summary value, when the estimate is modified, the value range cannot be greater than the estimate value of the parent.

Here, the check rule for the estimate of the sub-work item is as follows.

The check rule for the estimate of the parent item (node, other sub-work item): in response to the estimate of the parent being not empty and not a summary value, when the estimate is modified, the value range cannot be greater than the estimate value of the parent.

The check for the estimate of the child item (other sub-work item, node under the sub-work item): in response to there being nodes and other sub-work items under the sub-work item, when the estimate is modified, the estimate cannot be less than the sum of the estimates of the first-level sub-work item and/or the nodes.

The summarization rule for the estimate of the sub-process node is as follows.

In response to there being a parent process node, and the estimate of the parent process node being empty or a summary value, the estimate value that is modified is summarized and appended to the estimate of the parent. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified estimate is summarized to the parent exceeding the filled value of the parent's parent estimate, the modification is unsuccessful.

The summarization rule for estimate of the normal node is as follows.

In response to there being a parent process node and/or a sub-work item, and the estimate of the parent being empty or a summary value, the value that is modified is summarized and appended to the estimate of the parent. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified estimate is summarized to the parent exceeding the filled value of the parent's parent estimate, the modification is unsuccessful.

The summarization rule for the estimate of the sub-task is as follows.

In response to the estimate of the parent node being empty or a summary value, the value that is modified is summarized and appended to the estimate of the parent. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified estimate is summarized to the parent exceeding the filled value of estimate for the parent's other parent, the modification is unsuccessful.

The summarization rule for the estimate of the sub-work item is as follows.

In response to the estimate of the parent node and/or the sub-work item being empty or a summary value, the value that is modified is summarized and appended to the estimate of the parent. The scheduling of the parent is increased through linkage. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified estimate is summarized to the parent exceeding the filled value of the estimate for the parent's other parent, the modification is unsuccessful.

In some embodiments, the check rule for the actual work hours is as follows.

Here is the check rule for the actual work hours of the sub-process node. The check for the work hours of the parent item (parent process node): in response to the work hours of the parent being not empty and not a summary value, when the work hours are modified, the value range cannot be greater than the work hours value of the parent. The check for the work hours of the child item: in response to there being nodes in the sub-process, when the work hours are modified, the work hours cannot be less than the sum of the work hours of the nodes thereunder.

Here is the check rule for the actual work hours of the normal node. The check for the work hours of the parent item (sub-process node, root instance, sub-work item): in response to the work hours of the parent being not empty and not a summary value, when the work hours are modified, the time range cannot be greater than the work hours value of the parent. The check for the work hours of the child item (sub-task, sub-work item): in response to there being only sub-tasks under the node, when the work hours are modified, the work hours cannot be less than the sum of the work hours of the tasks thereunder; in response to there being only sub-work items under the node, when the duration is modified, the duration cannot be less than the duration between the earliest start time and the latest end time of the first-level sub-work item; when both are included, the scheduling of the sub-task and the first-level sub-work item are calculated in a combined manner.

Here is the check rule for the actual work hours of the sub-task. The check for the work hours of the parent item (node): in response to the work hours of the parent being not empty and not a summary value, when the work hours are modified, the value range cannot be greater than the work hours value of the parent. And none for the check for the work hours of the child item.

Here is the check rule for the actual work hours of the sub-work item. The check for the work hours of the parent item (node, other sub-work item): in response to the work hours of the parent node being empty or a summary value, the value that is modified is summarized and appended to the work hours of the parent; in response to the work hours of the parent being not empty and not a summary value, when the work hours are modified, the value range cannot be greater than the work hours value of the parent. The check for the work hours of the child item (other sub-work item, node under the sub-work item): in response to there being nodes and other sub-work items under the sub-work item, when the work hours are modified, the work hours cannot be less than the sum of the work hours of the first-level sub-work item and/or the nodes.

In some embodiments, the summarization rule for the actual work hours is as follows.

Here, the summarization rule for the actual work hours of the sub-process node is as follows. In response to there being a parent process node, and the work hours of the parent process node being empty or a summary value, the modified work hours value is summarized and appended to the work hours of the parent. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified actual work hours are summarized to the parent exceeding the filled value of the actual work hours for the parent's other parent, the modification is unsuccessful.

Here, the summarization rule for the actual work hours of the normal node is as follows. In response to there being a parent process node and/or a sub-work item, and the work hours of the parent being empty or a summary value, the value that is modified is summarized and appended to the work hours of the parent. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified actual work hours are summarized to the parent exceeding the filled value of the actual work hours for the parent's other parent, the modification is unsuccessful.

Here, the summarization rule for the actual work hours of the sub-task is as follows. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified actual work hours are summarized to the parent exceeding the filled value of the actual work hours for the parent's other parent, the modification is unsuccessful.

Here, the summarization rule for the actual work hours of the sub-work item. When the work hours of the parent node and/or the sub-work item are empty or a summary value, the value that is modified is summarized and appended to the work hours of the parent. When summarization is performed on a direct parent, which triggers the check and summarization rule of the parent's predecessor, summarization and/or check need to be performed layer by layer to the parent level of the parent until there is a filled value at the nearest level, or summarization is always performed to the root instance. When the currently modified actual work hours are summarized to the parent exceeding the filled value of the actual work hours for the parent's other parent, the modification is unsuccessful.

Further referring to FIG. 5, as an implementation of the methods shown in the above figures, the present disclosure provides an embodiment of a project management apparatus, and the apparatus embodiment corresponds to the method embodiment shown in FIG. 1, and the apparatus may be applied to various electronic devices specifically.

As shown in FIG. 5, the project management apparatus in this embodiment includes: a check unit 501, configured to, in response to detecting a modification operation of modifying a value of a first item to a target value, determine, according to a parent item and/or a child item of the first item, whether the target value passes a check; and an update unit 502, configured to, in response to the target value passing the check, and in response to the first item having a parent item and a parent item value of the parent item being empty or being a type of a summary value, update the parent item value according to the target value that passes the check, where the type of the summary value indicates that the parent item value is obtained by summarizing values of other items.

In this embodiment, the specific processing of the check unit 501 and the update unit 502 of the project management apparatus and the technical effects thereof may refer to the related description of S101 and S102 in the corresponding embodiment of FIG. 1 respectively, which will not be repeated here.

In some embodiments, the apparatus is further configured to: in response to the target value passing the check, display the target value.

In some embodiments, the step in which in response to detecting the modification operation of modifying the value of the first item to the target value, determining, according to the parent item and/or the child item of the first item, whether the target value passes the check includes one or more of followings. In response to the first item having a parent item, determining that the target value passes the check in response to the parent item value of the parent item being empty. In case that the first item has the parent item, determining that the target value passes the check in response to the parent item value of the parent item being not empty and being a type of a summary value. In case that the first item has the parent item, determining whether the target value is greater than the parent item value in response to the parent item value of the parent item being not empty and being a type of a fill value; and determining that the target value passes the check in response to the target value being not greater than the parent item value. In case that the first item has the parent item, determining whether a time range indicated by the target value is greater than a time range indicated by the parent item value in response to the parent item value of the parent item being not empty and being a type of a fill value; and determining that the target value passes the check in response to the time range indicated by the target value being not greater than the time range indicated by the parent item value.

In some embodiments, the step in which in response to detecting the modification operation of modifying the value of the first item to the target value, determining, according to the parent item and/or the child item of the first item, whether the target value passes the check includes one or more of followings. In case that the first item has the child item, determining whether the target value is less than a child item value of the child item in response to the child item value of the child item being not empty; and determining that the target value passes the check in response to determining that the target value is not less than the child item value. In case that the first item has the child item, determining whether a time range indicated by the target value is less than a time range indicated by the child item value in response to the child item value of the child item being not empty; and determining that the target value passes the check in response to determining that the time range indicated by the target value is not less than the time range indicated by the child item value.

In some embodiments, the apparatus is further configured to: in response to the target value failing to pass the check, display first prompt information, where the first prompt information is used to prompt that the target value conflicts with the parent item and/or the child item.

In some embodiments, the apparatus is further configured to: before the modification operation, display second prompt information for the first item, where the second prompt information is used to prompt a value range of the first item, where the value range of the first item is generated according to the parent item and/or the child item of the first item.

In some embodiments, the apparatus is further configured to: display third prompt information in response to a trigger operation on a work item value with the type of the summary value; where the third prompt information is used to prompt that in response to the work item value of the type of the summary value being modified, the work item value that is modified constitutes a constraint on a child item corresponding to the work item value.

In some embodiments, in response to detecting the modification operation of modifying the value of the first item to the target value, determining whether an instance to which the first item belongs is a constraint type that is preset, where the constraint type that is preset includes one or more of: a sub-process node, a node, a sub-task, or a sub-work item; and the step in which in response to detecting the modification operation of modifying the value of the first item to the target value, determining, according to the parent item and/or the child item of the first item, whether the target value passes the check includes: determining, according to the parent item and/or the child item of the first item, whether the target value passes the check based on determining that the instance to which the first item belongs is the constraint type that is preset and in response to detecting the modification operation of modifying the value of the first item to the target value; and the apparatus is further configured to perform one or more of followings: configuring the constraint type in a work item management space of the project management system; and in response to a first constraint control of a planning sheet being in an on state, configuring the constraint type in a planning sheet interface of the project management system.

In some embodiments, the step in which in response to the first constraint control of the planning sheet being in the on state, the constraint type is configured in the planning sheet interface of the project management system includes one or more of followings: configuring the constraint type for a plurality of work items in the planning sheet; and configuring the constraint type for a single work item in the planning sheet.

In some embodiments, the content type of the first item includes one or more of: a planned scheduling, a planned duration, an estimate, and actual work hours; and

In some embodiments, the first item is the planned scheduling, and the target value is a value of the planned scheduling; and the apparatus is further configured to: in response to the value of the planned scheduling passing the check, updating a value of a duration according to the value of the planned scheduling that passes the check.

In some embodiments, the apparatus is further configured to: in response to deleting the target value, generate the summary value of the first item according to the child item of the first item.

Please refer to FIG. 6, which illustrates an exemplary system architecture in which the project management method according to an embodiment of the present disclosure may be applied.

As shown in FIG. 6, the system architecture may include terminal devices 601, 602, and 603, a network 604, and a server 605. The network 604 is a medium used to provide a communication link between the terminal devices 601, 602, and 603 and the server 605. The network 604 may include various connection types, such as wired and wireless communication links or fiber-optic cables.

The terminal devices 601, 602, and 603 may interact with the server 605 through the network 604 to receive or send messages or the like. Various client applications, such as web browser applications, search applications, and news information applications, may be installed on the terminal devices 601, 602, and 603. The client applications in the terminal devices 601, 602, and 603 may receive instructions from users and complete corresponding functions according to the instructions from the users, for example, add corresponding information to information according to the instructions from the users.

The terminal devices 601, 602, and 603 may be hardware or software. When the terminal devices 601, 602, and 603 are hardware, they may be various electronic devices with a display screen and supporting web browsing, including but not limited to smart phones, tablet computers, e-book readers, MP3 players (Moving Picture Experts Group Audio Layer III, Dynamic Image Expert Compression Standard Audio Level 3), MP4 (Moving Picture Experts Group Audio Layer IV, Dynamic Image Expert Compression Standard Audio Level 4) players, laptop computers, desktop computers, etc. When the terminal devices 601, 602, and 603 are software, they may be installed on the above-mentioned electronic devices. It may be implemented as multiple software or software modules (such as software or software modules for providing distributed services), or a single software or software module. There is no specific limitation here.

The server 605 may be a server that provides various services, for example, receiving information acquisition requests sent by the terminal devices 601, 602, and 603, and acquiring display information corresponding to the information acquisition requests through various means according to the information acquisition requests. Relevant data of the display information is sent to the terminal devices 601, 602, and 603.

It should be noted that the project management method provided in the embodiments of the present disclosure may be performed by the terminal device. Correspondingly, the project management apparatus may be provided in the terminal devices 601, 602, and 603. In addition, the project management method provided in the embodiments of the present disclosure may also be performed by the server 605. Correspondingly, the project management apparatus may be provided in the server 605.

It should be understood that the number of terminal devices, networks, and servers in FIG. 6 is merely illustrative. According to implementation requirements, there may be any number of terminal devices, networks, and servers.

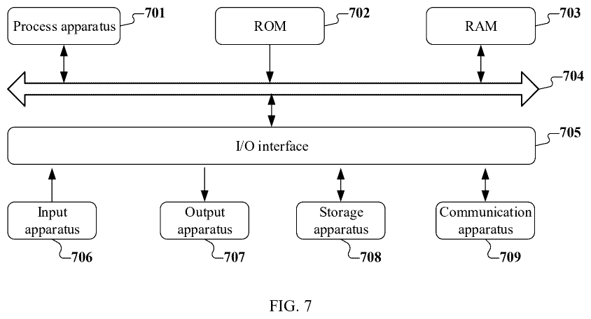

Referring to FIG. 7 below, which illustrates a structural diagram of an electronic device (such as the terminal device or the server in FIG. 6) suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer, a portable multimedia player (PMP), an in-vehicle terminal (such as an in-vehicle navigation terminal), and a fixed terminal such as a digital TV and a desktop computer. The electronic device shown in FIG. 7 is merely an example and should not impose any limitation to the function and scope of use of the embodiments of the present disclosure.

As shown in FIG. 7, the electronic device may include a processing apparatus 701 (such as a central processing unit and a graphics processor), which may perform various appropriate actions and processing according to a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatus may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; a storage apparatus 708 including, for example, a magnetic tape and a hard disk; and a communication apparatus 709. The communication apparatus 709 may allow the electronic device to perform wireless or wired communication with other devices to exchange data. Although FIG. 7 shows the electronic device having various apparatus, it should be understood that not all of the illustrated apparatus are necessarily implemented or provided. Alternatively, more or fewer apparatus may be implemented or provided.

Specifically, according to the embodiments of the present disclosure, the processes described above with reference to the flowcharts may be implemented as a computer software program. For example, an embodiment of the present disclosure includes a computer program product, which includes a computer program carried on a non-transitory computer-readable medium, and the computer program includes program codes for executing the methods shown in the flowcharts. In such an embodiment, the computer program may be downloaded and installed from the network through the communication apparatus 709, or installed from the storage apparatus 708, or installed from the ROM 702. When the computer program is executed by the processing apparatus 701, the preceding functions defined in the methods of the embodiments of the present disclosure are executed.

It should be noted that the preceding computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier, where computer-readable program codes are carried in the data signal. The data signal propagated in this manner may be in multiple forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program codes included on the computer-readable medium may be transmitted by any suitable medium, including but not limited to: a wire, an optical cable, a radio frequency (RF), etc., or any suitable combination thereof.

In some implementations, the clients and servers may communicate using any currently known or future developed network protocol such as the HyperText Transfer Protocol (HTTP), and may be interconnected with any form or medium of digital data communication (such as a communication network). Examples of the communication network include a local area network (“LAN”), a wide area network (“WAN”), an inter-network (such as the Internet), a peer-to-peer network (such as an ad hoc network), and any currently known or future developed network.

The preceding computer-readable medium may be included in the preceding electronic device, or may exist alone without being assembled into the electronic device.

The preceding computer-readable medium carries one or more programs, and when the one or more programs are executed by the electronic device, the electronic device is caused to: in response to detecting a modification operation of modifying a value of a first item to a target value, determine, according to a parent item and/or a child item of the first item, whether the target value passes a check; and in response to the target value passing the check, and in response to the first item having a parent item and a parent item value of the parent item being empty or being a type of a summary value, update the parent item value according to the target value that passes the check, where the type of the summary value indicates that the parent item value is obtained by summarizing values of other items.

The computer program codes for executing the operations of the present disclosure may be written in one or more programming languages or a combination thereof, where the preceding programming languages include object-oriented programming languages such as Java, Smalltalk, C++, and also include conventional procedural programming languages such as C or similar programming languages. The program codes may be executed entirely on a user's computer, partly on the user's computer, as a stand-alone software package, partly on the user's computer and partly on a remote computer, or entirely on the remote computer or server. In the case involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments described in the present disclosure may be implemented in software or hardware. The name of a unit does not constitute a limitation on the unit itself under certain circumstances. For example, a check unit may also be described as “a unit that determines whether the target value passes the check”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. A more specific example of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description is merely preferred embodiments of the present disclosure and explanation of the applied technical principles. It should be understood by those skilled in the art that the scope of disclosure involved in the present disclosure is not limited to the technical solutions formed by the specific combination of the above technical features, and should also cover other technical solutions formed by any combination of the above technical features or equivalent features thereof without departing from the above disclosure concept. For example, the technical solution formed by replacing the preceding features with technical features with similar functions disclosed in the present disclosure (but not limited to).

In addition, although operations are depicted in a particular order, it should not be understood as requiring these operations to be performed in the specific order shown or in a sequential order. Under certain circumstances, multitasking and parallel processing may be advantageous. Similarly, although the above discussion contains several specific implementation details, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are merely exemplary forms for implementing the claims.

1. A project management method, comprising:
determining, according to a parent item and/or a child item of a first item, whether a target value passes a check, in response to detecting a modification operation of modifying a value of the first item to the target value; and
updating a parent item value according to the target value that passes the check, in response to the target value passing the check and in response to the first item having the parent item and the parent item value of the parent item being empty or being a type of a summary value, wherein the type of the summary value indicates that the parent item value is obtained by summarizing values of other items.

2. The method according to claim 1, further comprising:
displaying the target value in response to the target value passing the check.

3. The method according to claim 1, wherein determining, according to the parent item and/or the child item of the first item, whether the target value passes the check in response to detecting the modification operation of modifying the value of the first item to the target value comprises one or more of followings:
in case that the first item has the parent item, determining that the target value passes the check in response to the parent item value of the parent item being empty;
in case that the first item has the parent item, determining that the target value passes the check in response to the parent item value of the parent item being not empty and being the type of the summary value;
in case that the first item has the parent item, determining whether the target value is greater than the parent item value in response to the parent item value of the parent item being not empty and being a type of a fill value; and determining that the target value passes the check in response to the target value being not greater than the parent item value; and
in case that the first item has the parent item, determining whether a time range indicated by the target value is greater than a time range indicated by the parent item value in response to the parent item value of the parent item being not empty and being the type of the fill value; and determining that the target value passes the check in response to the time range indicated by the target value being not greater than the time range indicated by the parent item value.

4. The method according to claim 1, wherein determining, according to the parent item and/or the child item of the first item, whether the target value passes the check in response to detecting the modification operation of modifying the value of the first item to the target value comprises one or more of followings:
in case that the first item has the child item, determining whether the target value is less than a child item value of the child item in response to the child item value of the child item being not empty; and determining that the target value passes the check in response to determining that the target value is not less than the child item value; and
in case that the first item has the child item, determining whether a time range indicated by the target value is less than a time range indicated by the child item value in response to the child item value of the child item being not empty; and determining that the target value passes the check in response to determining that the time range indicated by the target value is not less than the time range indicated by the child item value.

5. The method according to claim 1, further comprising:
in response to the target value failing to pass the check, displaying first prompt information, wherein the first prompt information is used to prompt that the target value conflicts with the parent item and/or the child item.

6. The method according to claim 1, further comprising:
before the modification operation, displaying second prompt information for the first item, wherein the second prompt information is used to prompt a value range of the first item, wherein the value range of the first item is generated according to the parent item and/or the child item of the first item.

7. The method according to claim 1, further comprising:
displaying third prompt information in response to a trigger operation on a work item value with the type of the summary value,
wherein the third prompt information is used to prompt that in response to the work item value with the type of the summary value being modified, the work item value that is modified constitutes a constraint on a child item corresponding to the work item value.

8. The method according to claim 1, further comprising:
determining whether an instance to which the first item belongs is a constraint type that is preset in response to detecting the modification operation of modifying the value of the first item to the target value; and
determining, according to the parent item and/or the child item of the first item, whether the target value passes the check in response to detecting the modification operation of modifying the value of the first item to the target value comprises:
determining, according to the parent item and/or the child item of the first item, whether the target value passes the check based on determining that the instance to which the first item belongs is the constraint type that is preset and in response to detecting the modification operation of modifying the value of the first item to the target value,
wherein the constraint type that is preset comprises one or more of: a sub-process node, a node, a sub-task, or a sub-work item; and
the method further comprises one or more of followings:
configuring the constraint type in a work item management space of the project management system; and
in response to a first constraint control of a planning sheet being in an on state, configuring the constraint type in a planning sheet interface of the project management system.

9. The method according to claim 8, wherein configuring the constraint type in the planning sheet interface of the project management system in response to the first constraint control of the planning sheet being in the on state comprises one or more of followings:
configuring the constraint type for a plurality of work items in the planning sheet; or
configuring the constraint type for a single work item in the planning sheet.

10. The method according to claim 9, wherein a content type of the first item comprises one or more of:
a planned scheduling, a planned duration, an estimate, or actual work hours.

11. The method according to claim 10, wherein the first item is the planned scheduling, and the target value is a value of the planned scheduling; and
the method further comprises:
updating a value of a duration according to the value of the planned scheduling that passes the check in response to the value of the planned scheduling passing the check.

12. The method according to claim 1, further comprising:
in response to deleting the target value, generating the summary value of the first item according to the child item of the first item.

13. An electronic device, comprising:
at least one processor; and
at least one storage apparatus, configured to store one or more programs,
wherein the one or more programs, when executed by the at least one processor, cause the one or more processors to implement a project management method, and the method comprises:
determining, according to a parent item and/or a child item of a first item, whether a target value passes a check, in response to detecting a modification operation of modifying a value of the first item to the target value; and
updating a parent item value according to the target value that passes the check, in response to the target value passing the check and in response to the first item having the parent item and the parent item value of the parent item being empty or being a type of a summary value, wherein the type of the summary value indicates that the parent item value is obtained by summarizing values of other items.

14. The electronic device according to claim 13, wherein the method further comprises:
displaying the target value in response to the target value passing the check.

15. The electronic device according to claim 13, wherein determining, according to the parent item and/or the child item of the first item, whether the target value passes the check in response to detecting the modification operation of modifying the value of the first item to the target value comprises one or more of followings:
in case that the first item has the parent item, determining that the target value passes the check in response to the parent item value of the parent item being empty;
in case that the first item has the parent item, determining that the target value passes the check in response to the parent item value of the parent item being not empty and being the type of the summary value;
in case that the first item has the parent item, determining whether the target value is greater than the parent item value in response to the parent item value of the parent item being not empty and being a type of a fill value; and determining that the target value passes the check in response to the target value being not greater than the parent item value; and
in case that the first item has the parent item, determining whether a time range indicated by the target value is greater than a time range indicated by the parent item value in response to the parent item value of the parent item being not empty and being the type of the fill value; and determining that the target value passes the check in response to the time range indicated by the target value being not greater than the time range indicated by the parent item value.

16. The electronic device according to claim 13, wherein determining, according to the parent item and/or the child item of the first item, whether the target value passes the check in response to detecting the modification operation of modifying the value of the first item to the target value comprises one or more of followings:
in case that the first item has the child item, determining whether the target value is less than a child item value of the child item in response to the child item value of the child item being not empty; and determining that the target value passes the check in response to determining that the target value is not less than the child item value; and
in case that the first item has the child item, determining whether a time range indicated by the target value is less than a time range indicated by the child item value in response to the child item value of the child item being not empty; and determining that the target value passes the check in response to determining that the time range indicated by the target value is not less than the time range indicated by the child item value.

17. The electronic device according to claim 13, wherein the device further comprises:
in response to the target value failing to pass the check, displaying first prompt information, wherein the first prompt information is used to prompt that the target value conflicts with the parent item and/or the child item.

18. The electronic device according to claim 13, wherein the device further comprises:
before the modification operation, displaying second prompt information for the first item, wherein the second prompt information is used to prompt a value range of the first item, wherein the value range of the first item is generated according to the parent item and/or the child item of the first item.

19. The electronic device according to claim 13, wherein the device further comprises:
displaying third prompt information in response to a trigger operation on a work item value with the type of the summary value,
wherein the third prompt information is used to prompt that in response to the work item value with the type of the summary value being modified, the work item value that is modified constitutes a constraint on a child item corresponding to the work item value.

20. A non-transitory computer-readable medium, on which a computer program is stored, wherein the computer program, when executed by a processor, implements a project management method, and the method comprises:
determining, according to a parent item and/or a child item of a first item, whether a target value passes a check, in response to detecting a modification operation of modifying a value of the first item to the target value; and
updating a parent item value according to the target value that passes the check, in response to the target value passing the check and in response to the first item having the parent item and the parent item value of the parent item being empty or being a type of a summary value, wherein the type of the summary value indicates that the parent item value is obtained by summarizing values of other items.
